(19) United States
(12) Patent Application Publication
(10) Pub. No.: US 2026/0363254 A1
(43) Pub. Date: Nov. 19, 2026

(54) Simplified Preparation of Asian Dumplings Through Production of Shelf-Stable Ingredients

(71) Applicant: Samantha Tilly Mui, Chicago, IL (US)

(72) Inventor: Samantha Tilly Mui, Chicago, IL (US)

(21) Appl. No.: 19/207,737

(22) Filed: May 14, 2025

(51) Int. Cl. A21D 10/00; A23L 23/00

(52) U.S. Cl. CPC A21D 10/005; A23L 23/00

(57) ABSTRACT

A method for preparing Asian dumplings using a set of shelf-stable, curated components that are individually reconstituted. The process involves preparing a dough mix, a filling mix, and a dipping sauce mix, each formulated to remain shelf-stable for extended periods until use. The components are reconstituted with liquids such as water, soy sauce, or sesame oil, following a precise, step-by-step sequence that ensures their transformation back to fresh-like textures, flavors, and authenticity, ultimately resulting in a fully assembled dumpling experience. This method guarantees convenience, long shelf life, and a simplified approach to preparing fresh-tasting Asian dumplings compared to traditional dumpling-making methods.

### CROSS REFERENCES TO RELATED APPLICATION

This application claims the benefit of U.S. Provisional Patent Application No. 63/564,996, filed on May 20, 2024, entitled “Simplified Preparation of Asian Dumplings Through Production of Shelf-Stable Ingredients” the entire contents of which are hereby incorporated by reference.

### BACKGROUND OF THE INVENTION

### Field of the Invention

The present invention is related to the field of food production, and more specifically, to the creation of shelf-stable ingredients that simplify the preparation of certain Asian dough-based food products, such as dumplings.

### Description of the Related Art

It is typically thought that fresh ingredients are required to prepare high-quality food, and this is particularly the case with certain types of food items, such as Asian dumplings and other dough-based products. However, shopping to obtain the potentially large number of constituent ingredients can be time-consuming; particularly when such shopping must be frequent in order to obtain very fresh ingredients, and it may require searching in many different specialty stores to find the more exotic items for non-mainstream recipes. Due to this significant burden, many consumers may simply opt to prepare different, less complicated food items instead.

### BRIEF SUMMARY OF THE INVENTION

The present invention describes a method of making meals with fresh ingredients, particularly when those ingredients are uncommon or otherwise difficult to obtain, it can be difficult for consumers, requiring tedious shopping, often at specialty stores. Additionally, such shopping may need to be performed frequently, due to the short lifetimes of fresh ingredients. For these reasons, consumers may choose simply to forego attempting the preparation of such meals, opting instead for more mainstream meals that require less effort.

To address this problem for consumers, embodiments of the instant invention involve conceptually decomposing the meals into several key components and generating dehydrated versions of those components, which may then be stored and used for long periods, then reconstituted into substantially fresh form by the addition of the appropriate liquids. This product is sold as a kit with pre-measured and prepacked ingredients and all necessary tools required to prepare it. As a concrete example of these techniques, the remainder of this specification describes the preparation of Asian dumplings.

### DETAILED DESCRIPTION OF THE INVENTION

A dumpling is composed of a dough-based skin, into which a filling is sealed before cooking. The key components of Asian dumplings include a dough used to form the exterior shell of the dumpling, a filling material preferably meat or vegetables or sea-food placed into the inner cavity formed by the dumpling, and a sauce into which the dumpling can be dipped before consumption. The Key ingredients of making dumplings are dough and fillings; consumers also like sauces to dip dumplings which is also provided with the product.

The dough is provided as a dried combination of bread flour, cornstarch, and salt. These dried ingredients have essentially no moisture and typically have a 2-3 year shelf life. The ingredients are blended and provided to consumers in within one or more sealed pouches to maintain the ratio of ingredients for the suitable recipe to further prevent moisture and increase the shelf life. Embodiments combining flour, cornstarch, and salt in the above-described ratio, when pan-fried by consumers, results in a crispy dumpling bottom that effectively retains moisture so that the dumpling remains succulent inside, while simultaneously allowing the upper portion of the dumpling to remain soft and chewy as it is steamed.

The filling is likewise provided as a mix of dried ingredients, which in some embodiments include ground ginger, garlic powder, air-dried cabbage, air-dried green onions, cornstarch, grinded mushroom powder, sugar, salt, and white pepper. These dried ingredients are mixed and may be provided together as a single packet, rather than requiring several separate fresh ingredients. When hot water is added to the ingredients, and the ingredients are left to bloom together, they become a thin paste in approximately 10 minutes, which may be easily mixed or otherwise incorporated into meat or other protein products and/or mixed with dipping sauces.

A dipping sauce pre-mix is additionally provided in the form of a pre-measured mixture comprising dehydrated ingredients, which may include, in certain embodiments, powdered white vinegar, sugar, sesame seeds, red pepper chili flakes, and air-dried cilantro. Upon the addition of one or more liquids such as hot water, sesame oil, or soy sauce the mixture reconstitutes to form a concentrated dipping sauce suitable for consumption with the dumpling product.

In the present meal kit, the dough, fillings, and sauces are supplied in dehydrated form, allowing them to be packaged together and marketed as a unified product. This arrangement simplifies the shopping experience for consumers and enables consistent flavor reproduction each time the meal is prepared.

Cooking by the consumer upon obtaining a package containing the various dried forms of the ingredients, the consumer prepares a corresponding meal (e.g., dumplings) by mixing the dried forms with an appropriate corresponding liquid(s). For example, in the case of dumplings, hot (e.g., near-boiling) water is added to the dried dough mix until the resulting dough is malleable and able to be kneaded. (The addition of the hot water, and the kneading, effectively breaks down the gluten in the dough and prevents a rigid structure from forming in the dough, resulting in a particularly malleable dough.) Note that the reconstituted dough, when prepared in this manner, is smoother than the conventionally available dough mixes which are relatively drier and relatively lacking in moisture. It does not even require water to seal the edges of the dumpling but can be sealed merely by folding and pressing the dough when making the dough skin. Hot water is likewise added to the dehydrated filling mix, along with certain sauces or oils (e.g., soy sauce and sesame oil) that are either readily obtainable or included with the ingredient package. Hot water and sauce/oil are likewise used to dissolve the dehydrated dipping sauce mix. Meat or meat substitute is the only significant additional ingredient that the consumer should separately obtain; the remainder of the ingredients can be provided in the package in dehydrated form.

Providing the ingredients in dried form offers a multitude of benefits. For example, it offers consistency when preparing sizable quantities of food, ensuring uniformity in every batch. Moreover, it is cost-effective, allowing for efficient budget management in meal preparation. Additionally, its ability to preserve food without refrigeration facilitates easier distribution and storage, mitigating the risk of spoilage compared to perishable ingredients. Furthermore, it simplifies the cooking process by requiring only the addition of hot water to regain both the texture and flavor of fresh ingredients. This makes meal preparation accessible and more convenient for individuals of all skill levels. Coupled with the retention of nutrients and vitamins, as well as the reduction of food waste through extended shelf life, the dehydrated mix is a practical and sustainable solution for culinary endeavors. The rehydration of the dried ingredients by the addition of hot water softens dried vegetables quickly, restoring their texture more efficiently than cold water and expediting the cooking process. The heat from hot water helps activate the flavors in dried vegetables, enhancing the taste profile of a dumpling filling. Rehydrating with hot water helps preserve more nutrients than is possible with more extended cooking times, ensuring that the nutritional value of the ingredients is retained. Hot water ensures a uniform rehydration of vegetables, preventing any parts from remaining dry or tough and resulting in a consistently pleasing texture. The use of hot water significantly reduces rehydration time, making meal preparation more time-efficient, particularly for busy individuals or in professional kitchens.

A guidebook is also provided along with the kit for consumers to follow when using this kit containing the dehydrated ingredients and common tools (e.g., a rolling pin and a dumpling crimper) to prepare and cook Asian dumplings. The instructions are divided into several primary sections, corresponding to different stages of the food preparation, and for each of the stages, an automated code (e.g., a QR code) is provided that allows the consumer to quickly obtain an electronic link to additional information, such as instructional videos, about the stage.

Here-in the example of preparation of the dumplings. The dumpling preparation process is designed to be simple and completed in six main steps, with each step representing a specific part of the overall cooking process. The first step is to prepare dough by mixing flour and warm water, add the required flour-mix in a bowl then add water as much as mentioned and knead it until the dough is smoother, let the dough rest for 20-30 minutes better texture. The second step is preparing filling by adding boil water to reconstitute the filling mix before mixing the ingredients given in the kit like soy sauce and sesame oil with ground meat or vegan substitute or ingredient of the consumer's choice. The third step involves preparing the dipping sauce by combining hot water with the provided sauce mix, soy sauce, and sesame oil, and stirring the mixture until it returns to its original consistency. The fourth step involves forming the dumpling wrappers by taking individual portions of dough and using a rolling pin to flatten each portion into a thin, circular wrapper suitable for filling. The fifth step is to shape the dumplings by stuffing the prepared filling as prepared in the second step, the consumer may use a crimper tool provided with the kit to shape the dumplings. The sixth and final step is cooking the dumplings by pan frying them with cooking oil—first crisping the bottoms, then covering and steaming in the same pan for 6-8 minutes.

The provided instructions to cook the dumplings enable consumers to produce dumplings with a relatively high degree of consistency and repeatability. For even greater consistency on a mass scale, the organization providing the packages to consumers could alternatively franchise or otherwise distribute the packages to commercial restaurant locations and provide training to employees to enable them to quickly and uniformly produce the dumplings in a manner that is consistent across locations, leading to greater customer satisfaction.

What is claimed is:

1. A product for preparing Asian dumplings, the product comprising:
a) A dough mix comprising a dehydrated mix of flour, cornstarch, and salt;
b) A dehydrated filling mix; and
c) A dehydrated form of a dipping sauce;
d) Wherein each of the dough mix, the dehydrated filling mix, and the dehydrated dipping sauce are shelf-stable for at least 24 months, providing a convenient, long-lasting solution for preparing Asian dumplings.

2. The product of claim 1, wherein each pre-portioned component (the dough mix, the dehydrated filling mix, and the dehydrated dipping sauce) is individually formulated to maintain high shelf stability for extended periods, ensuring that each component retains its quality and freshness until reconstitution.

3. The product of claim 2, wherein the dough mix, dehydrated filling mix, and dipping sauce mix are each reconstituted separately with liquids before being combined to create the final dumplings, ensuring the shelf stability of each component is maintained while preserving the final product's freshness and authenticity.

4. The product of claim 1, further comprising written instructions illustrating a sequence of steps in preparing the food products using the product, with at least some of the steps including a QR code linking to a video that demonstrates how to perform those steps.

5. The product of claim 3, wherein the one or more liquids used for reconstitution of the dough, filling, and dipping sauce components comprise at least one of hot water, soy sauce, or sesame oil, enabling the preparation of fresh, flavorful dumplings while maintaining the shelf stability of the components during storage and transportation.
